(19) United States
(12) Patent Application Publication
(10) Pub. No.: US 2026/0365898 A1
(43) Pub. Date: Nov. 19, 2026

(54) BIOCHAR BASED ROAD TREATMENT PRODUCT

(71) Applicant: Metzler Forest Products, LLC, Reedsville, PA (US)

(72) Inventors: Michael A. Zock, Saxonburg, PA (US); Nate Metzler, Reedsville, PA (US)

(21) Appl. No.: 19/650,468

(22) Filed: Apr. 17, 2026

Related U.S. Application Data
(60) Provisional application No. 63/790,393, filed on Apr. 17, 2025.

(51) Int. Cl. C09K 3/18

(52) U.S. Cl. CPC C09K 3/185

(57) ABSTRACT

A cost effective, efficient, biochar based road treatment product for addressing snow and ice utilizes granular biochar particles that are sized between sand and rice for easy spreading. The biochar particles are preferably functionalized with a material assisting in minimizing the formation of ice and snow and/or aiding in its removal. In accordance with the present invention, sawdust is used to form the proper sized biochar, and following the pyrolysis process the biochar particles are quenched with an aqueous solution, including material that reduces the freezing temperature. Beet juice, salt solutions, and combinations thereof may be effectively used for quenching the granular biochar and infusing the biochar road treatment product with these agents.

### RELATED APPLICATIONS

The present application claims the benefit of U.S. patent application Ser. No. 63/790,393 filed Apr. 17, 2025, titled “Biochar Based Road Treatment Product”.

### BACKGROUND INFORMATION

### 1. Field of the invention

The present invention relates to road treatment products particularly for treating for snow and ice conditions.

### 2. Background Information

In northern climates roadways are often treated to minimize the effect of snow and ice. In norther climates, like New England, road salting is a necessity to keep people safe during snow or cold weather as they drive to work or take their kids to school. The amount of salt used for deicing roads and highways has increased over the years along with the year-round transportation of goods and services. The many benefits that road salting provides, however are matched by some opportunities for improvement. Road salt can contaminate drinking water, kill or endanger wildlife, increase soil erosion, and damage private and public property. Alternative methods are needed to mitigate these drawbacks.

The most common substance used for deicing roads and highways is Sodium Chloride (NaCl) or table salt, generally known as rock salt when spread on the road because of its much larger granules. As of 2024, it has been reported that nearly half a million tons is used annually in Massachusetts for winter road maintenance.

Rock salt is very effective at melting snow and ice and is considered to be relatively cost effective. However, this cost does not include the potential damage to property, infrastructure, or the environment. Rock salt can have corrosive effects in large quantities that affects cars, trucks, bridges, and roads resulting in approximately $5 billion dollars in annual repairs in the U.S. alone. In addition, road salt can also infiltrate nearby surface and ground waters and can contaminate drinking water reservoirs and wells. High sodium levels in drinking water affect people with high blood pressure, and high chloride levels in surface waters are toxic to some fish, bugs, and amphibians. Furthermore, excess road salt accumulates on roadside areas killing roadside plants and harming wildlife that eat the salt crystals. Salty roads also attract animals like deer and moose (who love licking up the salt), increasing the probability of accidents and roadkill. There are a reported excess of 2,000,000 deer vs vehicle collisions each year resulting is over 200 human fatalities and over 10,000 human injuries. As comparison there are more than 800 reported moose vs vehicle collisions each year resulting is over 400 human fatalities. Clearly there is a desire to avoid attracting deer and moose to the roadside.

The environmental toll and long-term costs of rock salt have inspired some states to search for alternative management practices. Magnesium chloride (MgCl₂) is considered to be safer than NaCl, but requires twice the amount to cover the same area, making it more expensive. Calcium chloride (CaCl₂) is safer for the environment, but is three times more expensive than NaCL and so is typically reserved for use in vulnerable areas.

Innovative solutions that limit the amount of rock salt needed are also being explored. Non-treatment solutions have been proposed, such as porous pavement, which is engineered to reduce runoff from roads and has been found reduce snow and ice cover. Porous or permeable pavement allows standing water to seep through, removing water from roads that would normally go through freeze-thaw periods, thus preventing ice formation on the roads. A recent study showed that the annual median snow/ice cover on porous pavement was three times lower than that of regular pavement, and that the low amounts of ice/snow accumulating on porous pavement led to a 77% reduction in annual salt used for maintenance.

Another technology that has been considered is solar roads, made up of engineered solar panels that can be walked and driven upon. This technology has the potential of converting every single road into a source of renewable energy. In addition to the added energy source, this technology could also eliminate the need for road salt by melting ice or snow through heating water in pipes embedded in the road.

Rhode Island has adopted several measures to reduce the amount of salt needed. Since 2012, the State has been applying a brine solution (23.3% salt-water solution) to the roads before a forecasted snow event. Known as anti-icing, this practice prevents the formation of frost on pavement, and its implementation has been increasing across New England.

Another alternative is the use a 50/50 salt and sand mixture. The sand doesn't help to melt the snow or ice but increases traction, reducing the amount of road salt required. After the snow or ice melts, however, the remaining sand mixture gets washed away, filling catch basins or adjacent waterbodies with sediment, which then requires additional work hours and money to maintain and keep the basins clear. Currently, only a small fraction (5%) of the sand dispersed in Rhode Island is removed; the rest gets washed away into adjacent water bodies: clouding the water and making it difficult for aquatic plants to photosynthesize.

Other alternatives include adding biodegradable substances like beet juice, pickle juice, and molasses to the salt solution to enhance performance. These salt additives lower the freezing point of water, slowing down the formation of ice; they also aid in traction, and make the solution stickier so less salt gets splashed off the roads and wasted.

The disadvantages of many current treatments have led to interest in new approaches. The EPA has acknowledged (www. EPA. Gov article “Winter is Coming! And with it, tons of salt on our roads.” December 2024) that “no perfect solution exists to keep our roads clear in winter” while highlighting the increased number of tools available to public works departments allowing for a tailored approach to clear roads in an environmentally conscious manner without risking driver safety.

It is clear there remains a need to increase the number of tools available to clear roads in an environmentally conscious manner without risking driver safety

### SUMMARY OF THE INVENTION

This invention is directed to a cost effective, efficient, biochar-based road treatment product for addressing snow and ice. The biochar-based road treatment product utilizes granular biochar particles that are sized preferably between about 0.5 mm to about 10 mm or roughly sized between sand {typically 0.0625 mm to 2 mm effective diameter, on average about 0.5 mm in effective diameter} and rice {generally 5-7 mm in length and 2-3 mm} for easy spreading. The biochar particles are preferably functionalized or infused with a material, such as a solution, assisting in minimizing the formation of ice and snow and/or aiding in its removal. In accordance with the present invention, sawdust is used to form the proper sized biochar, and following the pyrolysis process the biochar particles are quenched with an aqueous solution, including material that reduces the freezing temperature.

Specifically, the present invention contemplates the use of beet juice, salt solutions, and combinations thereof as preferred embodiments for infusing in the granular biochar. The infusion process may be by quenching the granular biochar and infusing the biochar with these agents. The infusion process may be by soaking or spraying the granular biochar after formation and thus infusing the biochar with these agents.

One aspect of the invention provides a biochar-based road treatment product comprising granular biochar particles sized for spreading, wherein the biochar particles are functionalized or infused with a material such as a solution assisting in minimizing the formation of ice and snow and/or aiding in its removal.

One aspect of the invention provides a method of treating roadways for snow and ice comprising the steps of spreading granular biochar particles on the roadway. The method of treating roadways for snow and ice according to invention preferably wherein the biochar particles are functionalized or infused with a material such as a solution assisting in minimizing the formation of ice and snow and/or aiding in its removal.

One aspect of the invention provides a method of forming a biochar-based road treatment product comprising the steps of forming granular biochar particles sized for spreading; and infusing the biochar particles with a solution assisting in minimizing the formation of ice and snow and/or aiding in its removal.

These and other advantages of the present invention will be described below in connection with the associated figures in which like reference numerals represent like elements throughout.

### BRIEF DESCRIPTION OF THE SEVERAL FIGURES

FIG. 1 is a side elevation view of a method of treating roadways for snow and ice comprising spreading granular biochar particle on the roadway. according to one embodiment of the present invention.

FIG. 2 schematically illustrates the formation of the biochar-based road treatment product shown in FIG. 1 according to one embodiment of the invention.

FIG. 3 schematically illustrates the formation of the biochar-based road treatment product shown in FIG. 1 according to one embodiment of the invention.

FIG. 4 schematically illustrates the formation of the biochar-based road treatment product shown in FIG. 1 according to one embodiment of the invention.

### DESCRIPTION OF THE PREFERRED EMBODIMENT

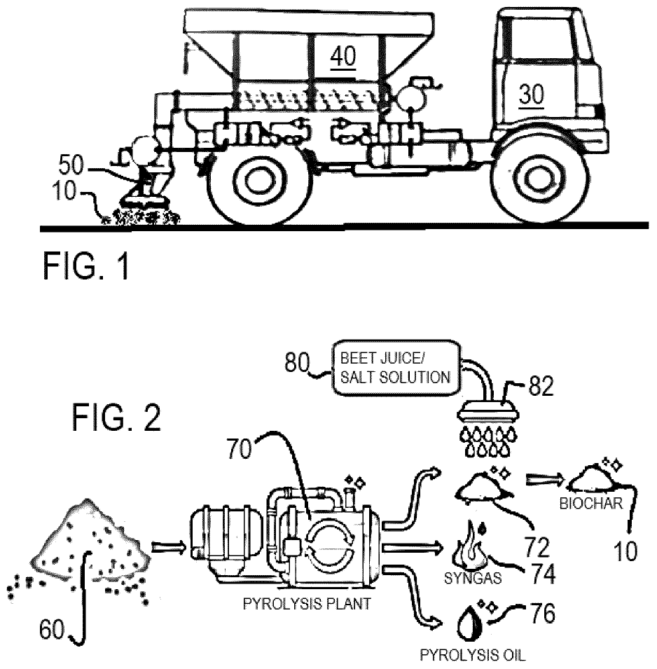

The present invention is directed to a biochar-based road treatment product 10 for treating roadways 20 which essentially comprises granular biochar particles sized for spreading. The granular biochar particles that are sized between sand and rice for easy spreading. Preferably the granular biochar particles are sized between about 0.5 mm to about 10 mm average diameter with “about” meaning +/−10%. The spreading on the roadway 20 of the product 10 will by typically by a truck 30 with a hopper 40 holding the product 10 and particulate spreader 50 applying the product 10 to the road surface as shown in FIG. 1.

The granular biochar-based product 10 is formed with biochar which is the lightweight black residue, made of carbon and ashes, remaining after the pyrolysis of biomass in a reactor 70, and is a form of charcoal. Biochar generally is defined by the International Biochar Initiative as “the solid material obtained from the thermochemical conversion of biomass in an oxygen-limited environment”. The granular biochar-based road treatment product 10 is a stable solid that is rich in pyrogenic carbon and can act as a soil amendment.

The granular biochar-based road treatment product 10 in the present invention specifically is preferably formed from sawdust product 60 and is a high-carbon, fine-grained residue that is produced via pyrolysis of hardwoods, such as in particular oaks, specifically red oak. It is the direct thermal decomposition of the hardwood sawdust biomass in the absence of oxygen (preventing combustion) in reactor 70, which process produces a mixture of solids 72 (the biochar), liquid (bio-oil) 76, and gas (syngas) products 74. Temperatures during pyrolysis in reactor 70 is generally 250-550 °C (523-823 K), 600-800 °C (873-1,073 K) in the reduction.

The granular biochar-based road treatment product 10 of the present invention is sawdust based and preferably hardwood. The sawdust 60 is used to yield the spreadable particulate product 10. Other sized starting material is possible if the resulting product remains spreadable. Screening can be used to make the resulting product into the desired spreadable range.

Hardwood is wood from dicot trees. Hardwoods have a more complex structure than softwoods and are often much slower growing as a result. The dominant feature separating “hardwoods” from softwoods is the presence of pores, or vessels. The granular biochar-based road treatment product 10 of the present invention is preferably from oak. An oak is a tree or shrub in the genus of Quercus of the beech family, Fagaceae. There are approximately 500 extant species of oaks. The granular biochar-based road treatment product 10 used in the present invention may be effectively formed from red oaks, Subgenus Quercus (the New World clade (or high-latitude clade), mostly native to North America); Section Lobatae (i.e., North American red oaks). The granular biochar-based road treatment product 10 used in the invention may be further sized, via screening into any desired range or ranges.

As detailed further below, preferably the biochar particles of product 10 are functionalized with a material 80 assisting in minimizing the formation of ice and snow and/or aiding in its removal, in one preferred embodiment the product is infused with a solution 80 assisting in minimizing the formation of ice and snow and/or aiding in its removal.

The biochar-based road treatment product 10 according to the invention may be effectively formed wherein following a pyrolysis process in reactor 70 the biochar particles 72 are quenched (via a sprayer 82) with an aqueous solution 80 including material that reduces the freezing temperature of water as shown in FIG. 2. The biochar-based road treatment product 10 may be formed wherein the material 80 that reduces the freezing temperature of water comprises beet juice, salt solutions, and combinations thereof. The quenching the biochar particles 72 with an aqueous solution 80 including material that reduces the freezing temperature of water is considered an infusion of the material 80 into the product 10. This process is described as wherein the product 10 is infused with a solution 80 assisting in minimizing the formation of ice and snow and/or aiding in its removal, although all or nearly all of the aqueous components of the solution 80 are no longer present after this functionalizing process.

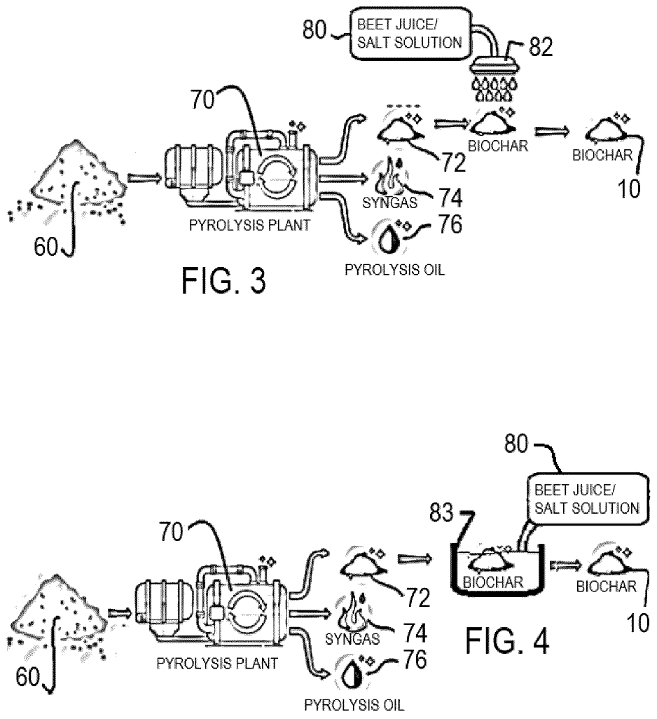

Alternatively, the functionalizing the biochar particles 72 with the solution 80 may be after the formation of the biochar, including after the quenching, by spraying the particles 72 with the aqueous solution via sprayer 82 as shown in FIG. 3. Alternatively, the functionalizing the biochar particles 72 with the solution 80 may be after the formation of the biochar, including after the quenching, by soaking the particles 72 in the aqueous solution via tank 83 as shown in FIG. 4. The functionalizing of the product 10 could occur before pyrolysis such as spraying or soaking the sawdust 60 with an aqueous solution 80 including material that reduces the freezing temperature of water, however this would increase the energy required for the pyrolysis step and is likely sub-optimal.

The invention may be summarized as using biochar product 10, sized for spreading with conventional equipment 50, as road grit or treatment for snow/ice management. The product 10 is preferably “functionalized” such as by infusing it with a beet juice aqueous solution, a salt aqueous solution or a combination beet juice—salt aqueous solution (or some other material that is useful in snow/ice management for roadways). The use of the quenching procedure to functionalize the product 10 is deemed optimal as the quenching step is already required for biochar production, however downstream treating the biochar 72 as shown in FIGS. 3-4 is also possible and effective. It is also possible the functionalizing of the product 10 could include a combination of processes both before and after pyrolysis and/or including quenching.

Additionally, spraying, soaking, quenching the product 10 with an aqueous solution 80 is not deemed the exclusive method of functionalizing the product as dry application of the desired functionalizing agent may be possible, however the quenching, spraying, or soaking infusion process described is deemed efficient and effective.

The present road treatment product 10 and associated method is more eco-friendly and reduces salt usage minimizing the “salt in fresh water” problem. Beet juice solutions as road treatments are conventionally spread with sprayers, which is a distinct piece of equipment than the road salt spreaders 50 thus the present invention allows a beet juice material to be spread like road salt and/or grit with existing equipment 50. This allows municipalities to utilize the present invention without investing in new equipment.

Further, as the granular biochar-based road treatment product 10 moves into water ways after application it acts to clean the water based upon the biochar. Similarly, if the granular biochar based road treatment product 10 moves into vegetated areas it acts as a beneficial soil amendment because of the biochar.

The preferred embodiments described above are illustrative of the present invention and not restrictive hereof. It will be obvious that various changes may be made to the present invention without departing from the spirit and scope of the invention. For example, non-infused biochar (like 72) may effectively be used in the method of treating roadways of the invention, but the infused product 10 is preferred. The precise scope of the present invention is defined by the appended claims and equivalents thereto.

What is claimed is:

1. A biochar-based road treatment product comprising granular biochar particles sized for spreading, wherein the biochar particles are functionalized with a material assisting in minimizing the formation of ice and snow and/or aiding in its removal.

2. The biochar-based road treatment product according to claim 1 wherein sawdust is used to form the proper sized biochar.

3. The biochar-based road treatment product according to claim 2 wherein following a pyrolysis process the biochar particles are quenched with an aqueous solution, including material that reduces the freezing temperature of water.

4. The biochar-based road treatment product according to claim 3 wherein the material that reduces the freezing temperature of water comprises beet juice, salt solutions, and combinations thereof.

5. The biochar-based road treatment product according to claim 1 wherein following a pyrolysis process the biochar particles are quenched with an aqueous solution, including material that reduces the freezing temperature of water.

6. The biochar-based road treatment product according to claim 5 wherein the material that reduces the freezing temperature of water comprises beet juice, salt solutions, and combinations thereof.

7. A method of treating roadways for snow and ice comprising the steps of spreading granular biochar particles on the roadway.

8. The method of treating roadways for snow and ice according to claim 7 wherein the biochar particles are functionalized with a material assisting in minimizing the formation of ice and snow and/or aiding in its removal.

9. The method of treating roadways for snow and ice according to claim 8 wherein sawdust is used to form the proper sized biochar.

10. The method of treating roadways for snow and ice according to claim 9 wherein following a pyrolysis process the biochar particles are quenched with an aqueous solution, including material that reduces the freezing temperature of water.

11. The method of treating roadways for snow and ice according to claim 10 wherein the material that reduces the freezing temperature of water comprises beet juice, salt solutions, and combinations thereof.

12. The method of treating roadways for snow and ice according to claim 8 wherein following a pyrolysis process the biochar particles are quenched with an aqueous solution, including material that reduces the freezing temperature of water.

13. The method of treating roadways for snow and ice according to claim 12 wherein the material that reduces the freezing temperature of water comprises beet juice, salt solutions, and combinations thereof.

14. A method of forming a biochar-based road treatment product comprising the steps of forming granular biochar particles sized for spreading; and functionalizing the biochar particles with a material assisting in minimizing the formation of ice and snow and/or aiding in its removal.

15. The method of forming a biochar-based road treatment product according to claim 14 comprising using sawdust to form the proper sized biochar.

16. The method of forming a biochar-based road treatment product according to claim 15 wherein following a pyrolysis process the biochar particles are quenched with an aqueous solution, including material that reduces the freezing temperature of water.

17. The method of forming a biochar-based road treatment product according to claim 16 wherein the material that reduces the freezing temperature of water comprises beet juice, salt solutions, and combinations thereof.

18. The method of forming a biochar-based road treatment product according to claim 14 wherein following the pyrolysis process the biochar particles are quenched with an aqueous solution, including material that reduces the freezing temperature of water.

19. The method of forming a biochar-based road treatment product according to claim 18 wherein the material that reduces the freezing temperature of water comprises beet juice, salt solutions, and combinations thereof.

20. The method of forming a biochar-based road treatment product according to claim 14, wherein the granular biochar particles sized for spreading are sized between about 0.5 mm to about 10 mm average diameter.
